(19) United States
(12) Patent Application Publication
(10) Pub. No.: US 2004/0026452 A1
(43) Pub. Date: Feb. 12, 2004

(54) Cold powder beverage dispenser

(76) Inventors: Gema Santiago, Flushing, NY (US); Jeffrey Badin, Flushing, NY (US)

Correspondence Address: Scully, Scott, Murphy & Presser, 400 Garden City Plaza, Garden City, NY, 11530, US

(21) Appl. No.: 10/213,498

(22) Filed: Aug. 7, 2002

(51) Int. Cl. B67D 5/62

(52) U.S. Cl. 222/146.6; 62/392

(57) ABSTRACT

A cold beverage dispensing device comprising a removable container with a spout for holding and dispensing ingredient powder, a cold water source, a mixing bowl in communication with the powder and cold water for combining the powder and water to form a beverage, an outlet for dispensing the beverage; a drinking cup system for placing a cup to capture the beverage as it is dispensed from the outlet.

### BACKGROUND OF THE INVENTION

The present invention relates to an automatic retailing device and specifically to an automatic cold powder beverage dispenser.

Vending machines have been around for many years, in fact, by some accounts, since the ancient Egyptians. The first modern vending machines were introduced to the United States in the late nineteenth century. These were designed to dispense gum, cigars and postcards. Since that time, vending machines have been adapted to dispense such things as blue jeans, live bait, flower arrangements, neckties and poached eggs.

It is common to find vending machines that dispense cold drinks such as soda, water and juices. It is also common to find hot drink dispensers for coffee, tea and hot chocolate. Cold drink dispensers either dispenses prepackaged drinks such as cans or bottles. Less popular are cold drink dispensers that dispense cold beverages made in the machine by combining cold water with a flavored fluid syrup. The syrup is contained in a container, and either mixed with the water in a mixing bowl or directly in a drinking cup.

Hot drink dispensers often have their ingredients in powder form. The powders are held in containers, which have an outlet for dispensing the powder into a mixing bowl or a drinking cup. For some beverages, the powder is combined with hot water to produce the final beverage. Other beverages rely on solvent extraction wherein agents are extracted by the heated solvent in solution.

Sports and nutritional drinks and fluid meal replacements have become a popular phenomenon. These drinks are used by the diet conscious, health conscious, athletes, those with limited time for meals and others. Today, billions of dollars a year are spent on such drinks.

These drinks come in many different varieties and include brands such as EAS, Muscletech, ProLab, Labrada, MHP, and Designer Whey. Each brand often has several varieties of drinks for discriminating tastes and purposes. Each variation often has different ingredients creating differences in their consistency, density, and thermal properties requiring different care and different recipes.

### SUMMARY OF THE INVENTION

The present invention is a cold beverage dispensing device comprising a removable container with a spout for holding and dispensing a powder ingredient; a cold water source; a mixing bowl in communication with the container and cold water for combining the powder and water to form a beverage; an outlet from the bowl for dispensing the beverage; a drinking cup system for placing a cup to capture the beverage as it is dispensed from the outlet. The device dispenses a cold beverage made from combining a cold, ingestible fluid with a powdered ingredient. The beverage is dispensed in quantities and containers for consumption on the premises. The dispenser may be adapted to be placed on a counter top or standma floor.

### BRIEF DESCRIPTION OF DRAWINGS

FIG. 1 is a block diagram of one embodiment of the invention.

FIG. 2 illustrates different embodiments of a container spout.

### DETAILED DESCRIPTION OF THE INVENTION

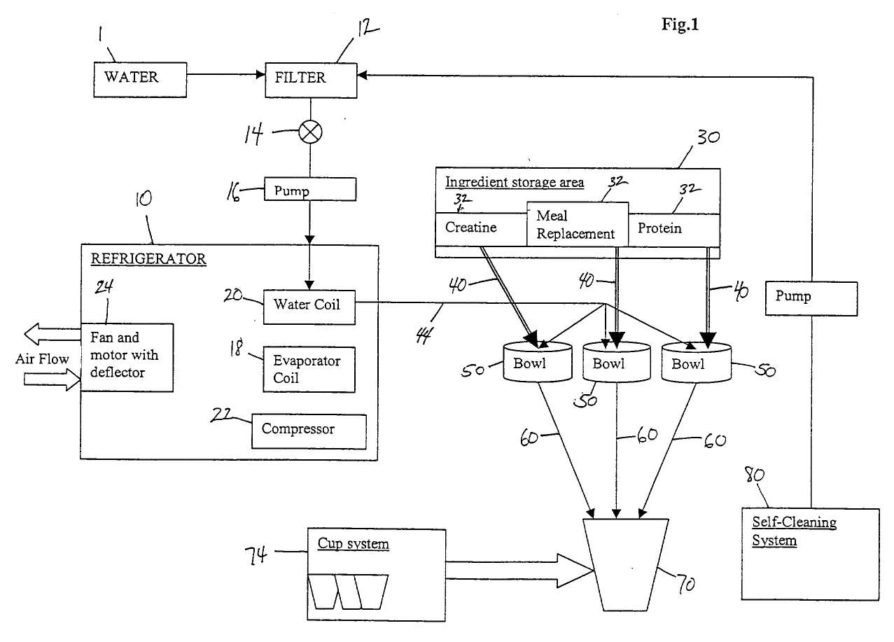

As shown in FIG. 1, the dispenser of the preferred embodiment of the present invention contains a refrigeration unit 10 and filter system 12. This filter system filters the water drawn or pumped in from a source 1. The water may also be stabilized at this stage. The water may be filtered by a scale trap, ceramic filter or some other known filter. A carbon filter may also be used.

Water flows through appropriate tubing from the filter system into the refrigeration unit 10. In the preferred embodiment, appropriate valving 14 and pumps 16 are provided for passing the water through the filter system and providing for enough water flowing through the refrigeration unit for supply of the beverages. Since the pressure from a main water source is usually inadequate for the device, a pump 16 is preferred to boost the pressure before entering the refrigeration unit 10.

The refrigeration unit 10 typically comprises an evaporator coil 18, a cooling coil 20 and a compressor 22. The refrigeration unit 10 may also provide appropriate valving and pumps to maintain and adjust the fluid pressure. Alternatively, the water may be replaced with juice, milk, or other ingestible fluid. The preferred fluid temperature is between 42-45° F. A ventilation fan 24 is also preferred for the refrigeration unit 10.

The powder ingredients are stored in separate containers 32 adapted for such purpose in an ingredient storage area 30. It is preferred that these containers 32 are removable and replaceable. The containers 32 should be adapted to maintain the freshness and cleanliness of the powders and prevent atmospheric contamination. The containers 32 are capable of holding enough powder to fulfill the mixing of multiple orders. The preferred container 32 holds between 3 pounds and 6 pounds and are manufactured from a sturdy plastic material such as poly(ethylene ter phthalate).

The powders preferred for the invention are creatine powders, meal replacement powders and protein powders. These are powders that are commonly used by health conscious and fitness conscious people. The creatine powders preferably comprise high quality creatine monohydrate. The creatine powders may also contain whey protein, sugars, maltodexhin, taurine, amino acids and other ingredients.

Meal replacement powders preferably comprise ingredients such as whey concentrates, maltodextrin, vitamins and minerals, fiber, essential fatty acids and calcium. The Protein powder preferably comprises whey, natural and artificial flavors and lecithin.

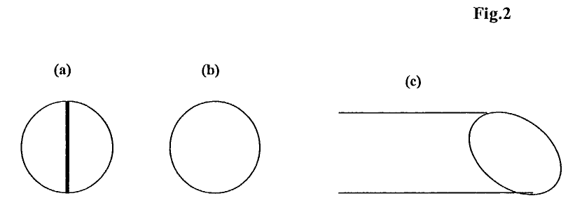

The containers 32 have spouts 40 that are adapted to dispense the powder in the appropriate measurements according to predetermined recipes. The spouts 40 may have flow restricting screws or mechanical or electric levers for proper metering. The powder is dispensed by opening the spout and the force of gravity. Alternative embodiments include an auger packer, wheel, paddle or rod to mechanically move the powder out or a pressurized gas. The spouts may be differently configured to dispense the powder evenly as is shown in FIG. 2. In FIG. 2(a), the container spout is simply a circular opening. FIG. 2(b) the circular opening is split by a middle partition. An oval cross-section of the spout is shown in FIG. 2(c).

The containers 32 preferably have means to prevent the powder from sticking together and to the container walls. Alternative embodiments include revolving wheels or paddles, agitators or shakers. These means may also aid the powder out of the spout.

Tubing 44 takes the cooled water to a mixing bowl or dispense head 50 that is constructed to receive the water and the powder ingredients. The recipes are mixed in a mixing bowl 50 configured to connect to the fluid tubing 44 and the powder spouts 40. The ingredients are added to the bowl 50 in the metered amounts and mixed. The mixing may be accomplished by a mechanical mixer such as a spoon, whisk, paddle, agitator or rod or using an electrical device such as a piezo mixer or pressure transducer or other suitable means.

Example recipes, used for illustration purposes only, include:

### EXAMPLE 1

Mix 80 grams of Labrada ProV60® with 16 ounces of water, or juice. Mix for 30 seconds.

### EXAMPLE 2

Mix 98 grams of EAS MuscleTech CellTech® with 15 ounces of water. Mix for 45 seconds.

Metering of the powder and fluid is critical to insure proper mixing. Mixing must incorporate the powder into the water to form a suspension. It is important not to mix excessively or the suspension might froth. If the suspension is not sufficiently mixed it will fall out of suspension. The mixing is done until the ingredients are thoroughly and sufficiently combined together. At which point the mixture is dispensed from the mixing bowl 50 into a cup through a dispensing spout 60. In the preferred embodiment, the present invention comprises several mixing bowls 50 to accommodate the varieties of recipes.

The placing of the cup 70 is controlled by a mechanical, pneumatic, or other device 74 that moves an individual cup 70 from a cup storage area to the dispensing spout 60. Different size cups may be used to provide for different varieties in size of the beverage. For example one could purchase a 10 ounce drink or a 16 ounce beverage.

A control processor automates the determination of the ingredients, recipe and its proper execution. The processor receives the desired input from a user through known means such as a touch sensitive monitor or switches, i.e. a user orders a 16 ounce chocolate Myoplex®. Temperature, pressure, rates of flow may all be controlled by the same processor or other processors. The processor may function as a terminal controlled from a computer network or act as a stand alone device.

The device may be configured as a counter top unit or a floor unit. It may also have powder detectors to detect when a container is near empty. The present invention preferably has a hygiene and quality control system as well as a self-cleaning system.

The hygiene and quality control system has drip trays and parts that may be dismantled and cleaned or replaced. Preferably, the dispenser has spouts and tubing that may be dismantled and sanitized.

In a preferred embodiment, the dispenser has a self-cleaning system 80 which provides hot water to all of the fluidic components. The water is heated to approximately 140° F. in the preferred embodiment.

All components in contact with the ingredients should be of material that will not physically degrade by contact with the ingredients or sanitizing and cleaning processes. The materials should not introduce any off-tastes or toxins into the systems and should not absorb any substantial amount of the ingredients or sanitizing or cleaning solutions.

Accordingly, it should be readily appreciated that the cold powder drink dispenser of the present invention has many practical applications. Additionally, although the preferred embodiment has been illustrated and described, it will be obvious to those skilled in the art that various modifications can be made without departing from the spirit and scope of this invention. Such modifications are to be considered as included in the following claims unless the claims expressly recite differently.

What is claimed is:

1. A cold beverage dispensing device comprising:
a removable container with a spout for holding and dispensing ingredient powder;
a cold water source;
a mixing bowl in communication with the container spout and cold water for combining the powder and water to form a beverage;
an outlet from the mixing bowl for dispensing the beverage;
a drinking cup system for placing a cup to capture the beverage as it is dispensed from the outlet.

2. A dispensing device as in claim 1 wherein:
a processor controls the amount of water and powder combined in the mixing bowl pursuant to a predetermined recipe that is indicated by a user.

3. A dispensing device as in claim 1 wherein:
mechanical means control the amount of water and powder combined in the mixing bowl pursuant to a predetermined recipe indicated by a user.

4. A dispensing device as in claim 1 wherein:
the spout of the container is adapted to dispense the powder at a predetermined flow rate.

5. A dispensing device as in claim 1 wherein:
each container contains a powder selected from the group consisting of creatine, meal replacement and protein.

6. A dispensing device as in claim 1 wherein:
the container has means for preventing the powder from sticking.

7. A dispensing device as in claim 1 wherein:
the container has a restricting screw to meter the flow of powder.

8. A dispensing device as in claim 1 wherein:
the container has an electrically controlled lever to meter the flow of powder.

9. A dispensing device as in claim 1 wherein:
an auger packer moves the powder into the bowl.

10. A dispenser as in claim 1 wherein:
the mixing bowl comprises a paddle and bowl of mixing the ingredients.

11. A dispenser as in claim 1 wherein:
an agitator shakes the bowl to mix the ingredients.

12. A dispensing device as in claim 1 further comprising:
a self-cleaning system that uses hot water to clean the fluidic components.
